(19) United States
(12) Patent Application Publication
(10) Pub. No.: US 2026/0009882 A1
(43) Pub. Date: Jan. 8, 2026

(54) SYSTEM AND METHOD FOR BEHAVIORAL EMITTER IDENTIFICATION, EMISSION TRACKING, AND ANOMOLY DETECTION

(71) Applicant: Raytheon Company, Tewksbury, MA (US)

(72) Inventors: Andrew W. Tudor, LOS ANGELES, CA (US); Andres Ivan Vila Casado, Culver City, CA (US); Esteban Luis Valles, Los Angeles, CA (US); Hannah McDonald, El Segundo, CA (US); Garry S. Oh, SANTA BARBARA, CA (US)

(21) Appl. No.: 18/762,027

(22) Filed: Jul. 2, 2024

(51) Int. Cl. G01S 7/36; G01S 7/02

(52) U.S. Cl. CPC G01S 7/36; G01S 7/021

(57) ABSTRACT

A system and method are described for emitter identification, emission tracking, and anomaly detection in an electronic warfare (EW) environment. Association results are obtained of waveforms of the emitters in a current dwell. The association results include a current distribution of inferred groupings of the waveforms. Features are generated for each waveform by comparing the current distribution and recent emitter historical behavior contained in a Dynamic Emitter Library (DEL). A probability of association with a track is determined for each waveform based on the features generated through the comparison. An identity of an emitter based on the probability and anomalous behavior of the emitter are inferred for each waveform.

### TECHNICAL FIELD

The present subject matter relates generally to electronic warfare (EW) systems and more specifically to methods and systems for identification, tracking, and anomaly detection of emitters in complex EW environments.

### BACKGROUND

EW involves the strategic use of the electromagnetic spectrum to detect, deceive, and disrupt enemy radar and communication systems while ensuring friendly use. In modern warfare, it is at a minimum useful to accurately determine whether to respond to electronic signals, particularly radar emissions, in EW environments. One challenge for a system in an EW environment is the effective identification and tracking of radar emitters, which is used for assessing threats and deploying appropriate countermeasures.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an electronic warfare environment according to some embodiments.

FIG. 2 illustrates a block diagram of an electronic device in accordance with some aspects.

FIG. 3 illustrates an electronic warfare system according to some embodiments.

FIG. 4 illustrates de-interleaving according to some embodiments.

FIG. 5 illustrates a receiver block diagram according to some embodiments.

FIG. 6 illustrates a tracking block diagram according to some embodiments.

FIG. 7 illustrates feature generation with a Dynamic Emitter Library (DEL) according to some embodiments.

FIG. 8 illustrates track association inference according to some embodiments.

FIG. 9 illustrates identification inference and anomaly score according to some embodiments.

FIG. 10 illustrates a method of Behavioral Emitter Identification, Emission Tracking, and Anomaly Detection in accordance with some aspects.

### DETAILED DESCRIPTION

Typical air-vehicle platforms in EW environments have strict receive/transmit duty cycles with only about 1-10% of the Active Electronically Scanned Array (AESA) duty cycle allowed for receive actions. Considering the sparsity of data and the waveform agility of modern threats, typical styles for identification and tracking are not sufficient to guarantee successful electronic attack (EA).

The system herein provides a more adaptive and intelligent system that is capable of learning from incoming data to identify and track both known and previously unknown (i.e., unseen) radar emitters. The system employs an architecture that integrates Machine Learning (ML) algorithms to dynamically classify and track radar emitters. The system described utilizes a combination of supervised and unsupervised ML algorithms to analyze pulse descriptor words (PDWs). This analysis enables the system to identify patterns and changes in emitter behavior that may not be documented in any database. This capability improves maintaining situational awareness and ensures that EW assets are accurately targeted and effective, thereby enhancing overall mission success in modern combat environments.

The system includes RF antennas and receivers configured to receive RF signals from an environment to model various aspects of the environment. The system is configured to detect and analyze pulses within received RF signals as part of the environment mapping or analysis. The analysis is used to obtain pulse parameters used to identify emitters, such as radar emitters. The system can be used in a wide variety of applications such as military, security, weather detection and forecasting, traffic enforcement, exploration, mapping, to identify the source of the pulses and determine what actions to take. In particular, a set of PDWs is determined from a digitized RF signal. The PDWs are supplied to signal processing blocks that process the pulse parameters to identify an emitter that is the most likely source of the PDWs. A library of known emitters is then updated and decision rules for future PDWs are adapted.

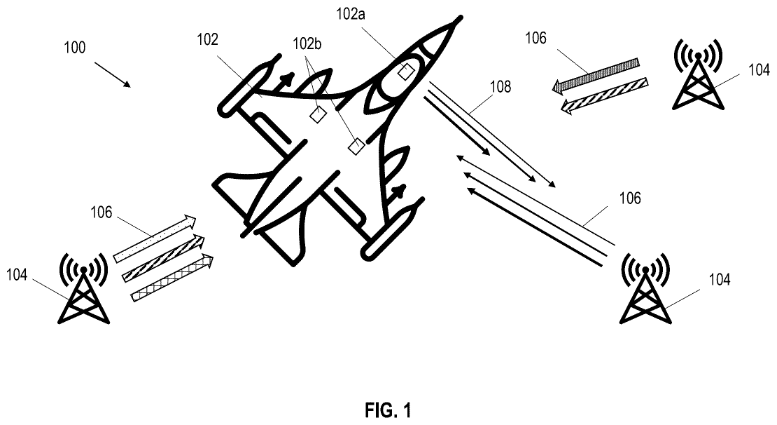

FIG. 1 illustrates an electronic warfare environment according to some embodiments. As shown, an aircraft 102 (or other vehicle in an EW environment) is operational through an environment 100 that contains multiple emitters 104. Each emitter 104 may be, for example, an enemy emitter or a friendly or neutral emitter (such as a base station operated by a carrier). Each emitter 104 may emit one or more signals 106 that are received at one or more antennas (or antenna arrays) 102b of the aircraft 102. Each of the signals 106 may have different characteristics, such as center frequency, amplitude, modulation category, or pulse width. One or more processors (or processing circuitry) 102a in the aircraft 102 may determine whether or not to take countermeasures 108 in response to reception of one or more of the signals 106 from one or more of the emitters 104. The countermeasures 108 may include, for example, electronic countermeasures such as emitting jamming signals or countering signals, or taking physical action such as engaging in evasive maneuvers.

The aircraft 102 has an onboard processor 102a to detect the signals 106 received by the antennas 102b. The processor 102a performs high-speed signal analysis and threat evaluation. The processor 102a may include, for example, a general-purpose processor, a central processor unit (CPU), an Advanced Reduced Instruction Set Computer (RISC) Machine (ARM), Digital Signal Processor (DSP), Field-Programmable Gate Array (FPGA), and/or Application-Specific Integrated Circuit (ASIC) among others. The processor(s) 102a may in combination handle a wide range of tasks and support a variety of software applications for signal analysis and response management, interact with other aircraft systems and for manage user interfaces within the aircraft 102, process signal data at high speeds (including transforming and analyzing the data), and configure processing operations to adapt to new threats or changes in the signal environment, among others.

The signals 106 originate from various emitters 104. The emitters may include hostile radar installations, electronic countermeasure systems, or communication signal transmitters, each capable of emitting complex modulated signals across a wide range of frequencies and power levels. The signals may employ techniques such as frequency hopping or phase modulation to evade detection and jamming, posing a significant challenge for electronic warfare systems. The signals 106 may include radar signals and communication signals, among others. Radar Signals are typically high-frequency pulses used for detection and ranging and may vary in pulse width, repetition frequency, and modulation techniques. Radar systems may use pulse compression techniques or frequency hopping to avoid jamming and detection.

Communication signals may be emitted by base stations, for example, and used by consumer or business/industrial devices.

The processor 102a in the aircraft 102 may use DSP techniques to analyze the signals 106. In general, the processor 102a may demodulate and decode the signals 106 to extract parameters such as frequency, phase, amplitude, and modulation type. The parameters may be analyzed by the processor 102a to classify the type of emitter 104 that has emitted each signal 106 and assess the potential threat the emitter 104 poses. The processor 102a may control emitters in the aircraft 102 to transmit electronic countermeasure signals in response to the analysis. The electronic countermeasure signals may be specifically designed to disrupt or deceive electronic systems and thus may include noise jamming signals, which are broad-spectrum emissions intended to mask various aircraft signals and interfere with the enemy's signal reception, or other jamming techniques like replicating or altering signals to confuse radar or communication systems (e.g., to suggest a different location or velocity of the aircraft 102) or electronic spoofing and deception techniques to mimic the characteristics of friendly or neutral entities to mislead enemy sensors.

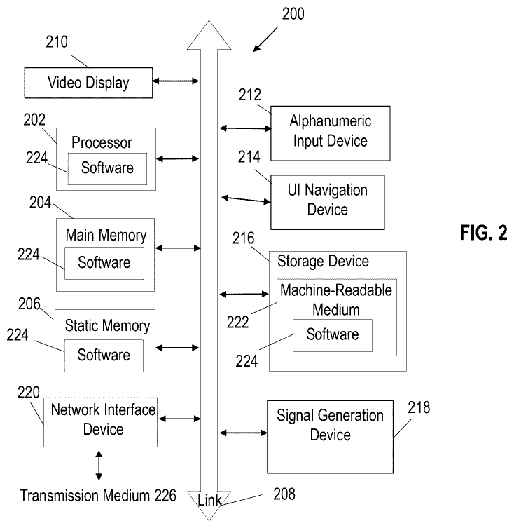

FIG. 2 illustrates a block diagram of an electronic device in accordance with some aspects. The electronic device 200 may be a specialized computer, dedicated equipment, or any machine in an EW vehicle (such as an aircraft) capable of executing instructions (sequential or otherwise) that specify actions to be taken by that machine in an EW environment. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The electronic device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The electronic device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The electronic device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The electronic device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the electronic device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the electronic device 200 and that cause the electronic device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), IEEE 202.11 family of standards, and wireless data networks. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology.

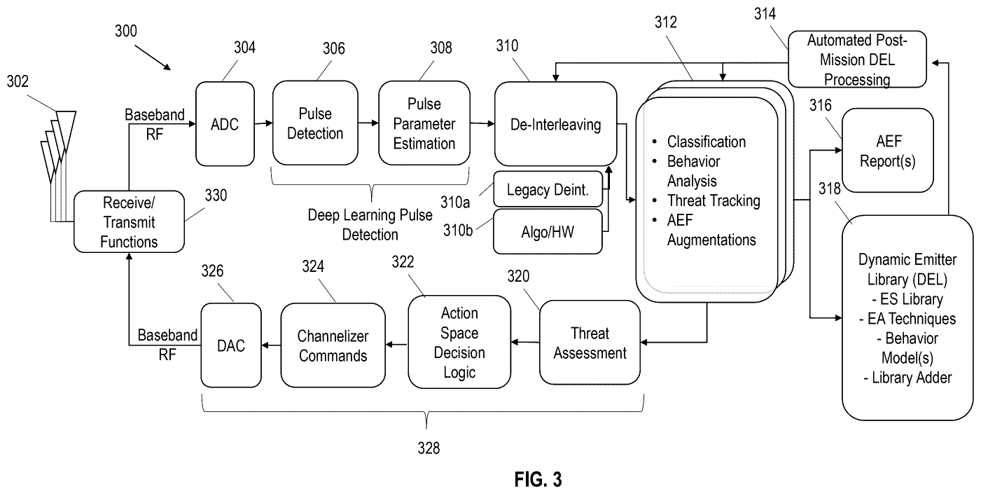

FIG. 3 illustrates an electronic warfare system according to some embodiments. The electronic warfare system 300 may be installed in the aircraft shown in FIG. 1. The electronic warfare system 300 includes one or more antennas 302 (or antenna arrays) that are configured to receive signals (i.e., waveforms) having a wide range of characteristics and from at least about a 180-degree range of reception (towards the ground). The signals are thus captured by a single or multiple set of antennas 302 at a center frequency, Fc.

Signals received by the antennas 302 may be supplied to receive/transmit circuitry 330 that provides receive/transmit functions. The receive/transmit circuitry 330 may include, for example, an RF front end that includes a circulator that permits transfer of the received signals from the antennas 302 to a receive chain of the electronic warfare system 300 or electronic countermeasure signals from a transmit chain of the electronic warfare system 300 to the antennas 302 for transmission of the electronic countermeasure signals. The receive/transmit circuitry 330 may also include one or more of amplifiers, filters, mixers, and buffers, for example. The mixers, for example, may be used to downconvert the received signals to baseband radio frequency (RF) signals, which are filtered by one or more filters to remove interference.

The analog baseband RF signals may be supplied to an analog-to-digital converter (ADC) 304. The digital signals created by the ADC 304 may be supplied to a pulse detector 306 and pulse parameter estimator 308 that estimates various parameters of the pulses from the ADC 304. The ADC 304, pulse detector 306, and pulse parameter estimator 308 may digitize the analog baseband RF signals into PDW that summarize the waveform parameters in the detected pulse. In some embodiments, a ML model may be used by the pulse detector 306 and pulse parameter estimator 308 to provide deep learning pulse detection.

In some embodiments, the pulse detector 306 may include a digital sampling circuit that converts the analog baseband RF signals to digital samples. These samples may be referred to as IQ samples since the samples can be represented as a complex number with real (I) and imaginary (Q) components. The pulse detector 306 determines which IQ samples belong to a pulse and which belong to periods of noise without pulses. In radar applications, radar signals may have large duty cycles in which pulses are only present for a fraction of the transmission time. Therefore, only retaining IQ samples from times in which pulses are present allows a reduction of samples to be processed. The pulse parameter estimator 308 may similarly be used to further reduce the representation of a pulsed waveform to a smaller number of parameters that describe the pulse as PDWs.

In particular, the environments in which the electronic warfare system 300 is used may have a number of active emitters that generate a high density of pulsed waveforms (i.e., pulses, or radar signals). As above, processing all of the pulses so generated using a power-limited embedded processor may be difficult at best. Accordingly, PDWs are used to describe the received pulses. A PDW is essentially a compact representation of various characteristics of an analog RF radar pulse. These characteristics include parameters such as pulse width, pulse repetition interval (PRI), pulse amplitude, angle of arrival, center frequency, and others depending on the specific receiver.

The output from the pulse parameter estimator 308 may be supplied to a de-interleaving module 310. The de-interleaving module 310 may include a legacy de-interleaving module 310a and a deep-learning algorithm or hardware 310b to provide de-interleaving of the PDWs. The de-interleaving module 310 may process the PDWs to infer which PDWs are emitted from the same emitter shown in FIG. 1. Such inference may utilize different sensors and measurements, as described in more detail below.

The output of the de-interleaving module 310 may be supplied to a multi-mode module 312 that provides a number of different functions based on the de-interleaved PDWs. The functions may include, for example, classification, behavioral analysis, threat tracking, and Active Emitter File (AEF) Augmentation. Classification may be used to infer the type and identity of a threat with different granularities (e.g., Target Engagement Radar, SA-20, Foe, Serial Number 123, . . . ). Behavioral analysis may be used to infer the operating mode of the radar and quantify any significant and/or unexpected changes in the waveform. AEF Augmentations may be used to supply downstream algorithms with new and useful information to enact Electronic Countermeasures (ECM) and supply other ML algorithms.

The output of the multi-mode module 312 is used to create an AEF report 316 and store the information from the multi-mode module 312 in a Dynamic Emitter Library (DEL) 318 onboard the aircraft. The DEL 318 may contain an electronic support (ES) library, electronic attack (EA) techniques, behavior model(s) of signals, and a library adder. Unlike an MDF, which is a database with rows of data such as Radar-A, Frequency A, PW-A, Modulation-A, the DEL 318 is a library of PDWs from different emitters used to train the ML algorithm to build a structure to determine to which class a received pulse belongs. The DEL 318 may include useful ML features and behavioral patterns that are added at inference time of the ML model. The information in the DEL 318 may be supplied to an automated emitter library update 314, which may provide automated processing to, among others, associate new emitter data with an existing emitter label, permitting re-training/updating of ML algorithms to incorporate the information so that subsequent observations of the same pattern permit correct classification. This avoids the use of a traditional MDF (or similar table) in the architecture described herein. Moreover, as the classifiers are used for training are lightweight compared to deep learning networks that use a large computer with GPUs for training, the library updates may occur during a mission. This also avoids complicated issues associated with adding new signals to the supervised library, as this process simply involves a fine tuning of supervised ML algorithms without manual parameter tuning. The output of the automated emitter library update 314 may be supplied to the multi-mode module 312 for subsequent use. The automated emitter library update 314 may be used to extract useful information in the DEL 318 to update various ML model logic. The automated emitter library update 314 may provide automated post-mission DEL processing in some embodiments.

The output of the multi-mode module 312 may also be used by a countermeasure module 328 to determine ECM priority and generate countermeasure waveform for transmission via the transmit chain. The countermeasure module 328 may include a threat assessment module 320 that determines from the multi-mode module 312 information the level of threat from the received signals, action space decision logic 322 that determines the appropriate action to take based on the threat assessment (e.g., jamming, evasion, nothing), a channelizer commands module 324 that creates the appropriate digital signals based on instructions from the action space decision logic 322, and a digital-to-analog converter (DAC) 326 that converts the PDWs from the channelizer commands module 324 to response baseband RF signals. The response baseband RF signals are supplied to the receive/transmit circuitry 330 for transmission by the antennas 302.

As above, the MDF-Free techniques described herein permit identification of the most likely source of a set of (radar-generated) RF pulses represented by pulse descriptions. The techniques combine different ML methods and synthesizes the ML methods with more traditional legacy radar detection algorithms resulting in an architecture that significantly improves the radar electronic support (ES) and radar/emitter identification performance in the presence of agile radar threats. A combination of supervised machine learning algorithms is used that target the identification of previously seen radars (i.e., known emitters), with unsupervised machine learning methods to track radars or radar modes that are unknown and have not been seen before and are not present in the training data. The techniques herein allow characterization and identification of active emitters that are being sensed by the receiver and results in a significant performance improvement in radar detection. The problem of adding new signals to the supervised library simply involves a fine tuning of the supervised algorithms and involves no manual parameter tuning, unlike MDF techniques.

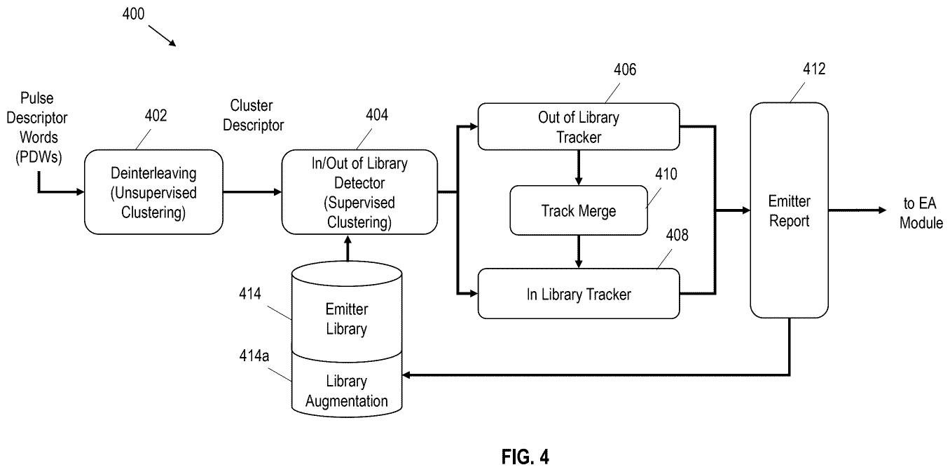

FIG. 4 illustrates a receiver block diagram according to some embodiments. The system 400 shown in FIG. 4 includes the antennas, the RF front end, digital sampler, pulse detector, and pulse parameter estimator described in relation to FIG. 3 to produce the PDWs, and provides more description of the multi-mode module of FIG. 3. The PDWs may describe the RF signal properties (emitter characteristics) of one or more of: Carrier Frequency (Fc), Pulse Amplitude (PA), Pulse Width (PW), Time of Arrival (TOA), Angle of Arrival (AOA), Pulse Repetition Interval (PRI), among others. The PDWs may thus include both intrinsic and extrinsic emitter characteristics.

As shown, the PDWs are supplied to a deinterleaver 402. The deinterleaver 402 may use one or more unsupervised ML algorithms to analyze the PDWs. The deinterleaver 402 may include a pulse parameter estimator that uses IQ samples from a pulse and produces PDWs that describe those samples. Once the PDWs are computed, the PDWs may be stored in a buffer on firmware. A typical size for such a buffer may be 1024 PDWs, although other sizes are possible. Once the PDWs are stored in the buffer, a flag is set to indicate that PDWs are ready to be processed. The unsupervised ML algorithm(s) cluster PDWs with similar statistical properties into clusters that are indicated by a PDW cluster descriptor. The cluster buffer resulting from the unsupervised ML algorithm(s) includes multiple clusters, each of which is defined by a set of cluster features and indicated by the cluster descriptor. Cluster analysis is an iterative process of knowledge discovery or interactive multi-objective optimization that involves trial and failure and is based on training data. Using unsupervised clustering immediately after the PDW generation results in significant reduction in the number of PDWs in the PDW buffer so that subsequent inference algorithms only process a representative set of PDWs in a cluster instead of all PDWs that have been generated by the pulse parameter estimator.

The output of the unsupervised ML algorithm(s) (e.g., mean value of the pulse features in a cluster) may be supplied to an IN/OUT OF LIBRARY DETECTOR 404 that contains a supervised classification algorithm that uses one or more supervised ML algorithms. Some or all of the cluster features may be used by the supervised classification algorithm and may be used by a cluster tracker, which may or may not be the same as the cluster features used by the supervised classification algorithm. The IN/OUT OF LIBRARY DETECTOR 404 may determine whether a PDW being analyzed has been originated by an in-library radar source or by an unknown or out of library (OOL) source. The supervised classification algorithm may be trained based on the PDWs from previously seen emitters. The PDWs may be either sampled from real warfare scenarios or simulated based on behaviors from known sources. When the supervised classification algorithm uses an ensemble of independent supervised ML algorithms trained with a library of known and labeled emitters (threats), the outputs may be supplied to an arbitrator to decide an in-library score for the emitter to be classified to be within a training library for high probability clusters, within the training library but with insufficient initial information to determine which class within the emitter library for medium or moderate probability PDW clusters, and out of the training library for low probability clusters. The supervised ML algorithms use intrinsic emitter characteristics, e.g., related to frequency, such as center frequency, pulse width, and pulse repetition pattern and may use extrinsic features to resolve underdetermined results.

The output of the IN/OUT OF LIBRARY DETECTOR 404 may be supplied to either an OOL tracker 406 or an In Library tracker 408. For PDWs analyzed by IN/OUT OF LIBRARY DETECTOR 404 that are categorized as OOL, the corresponding clusters are provided to OOL tracker 406. For PDWs analyzed by IN/OUT OF LIBRARY DETECTOR 404 that are categorized as in library, the corresponding clusters are provided to the In Library tracker 408. The information from the OOL tracker 406 may be merged with an In Library tracker 408 using a track merger 410, which may use a track merge algorithm to analyze the unlabeled OOL tracks and correlate the unlabeled OOL tracks to known In Library tracks.

The OOL tracker 406 and In Library tracker 408 each provides results in an emitter report 412. The emitter report may be supplied to an emitter library 414 for augmentation 414a as well as to an EA module for preparing countermeasures for transmission. Enabling augmentation 414a of the emitter library 414 to reflect changes in the EW environment is one result of labeling the OOL tracks. The feedback loop created by online training of the classifiers may improve the overall system performance by having an updated library that accurately represents the actual EW environment.

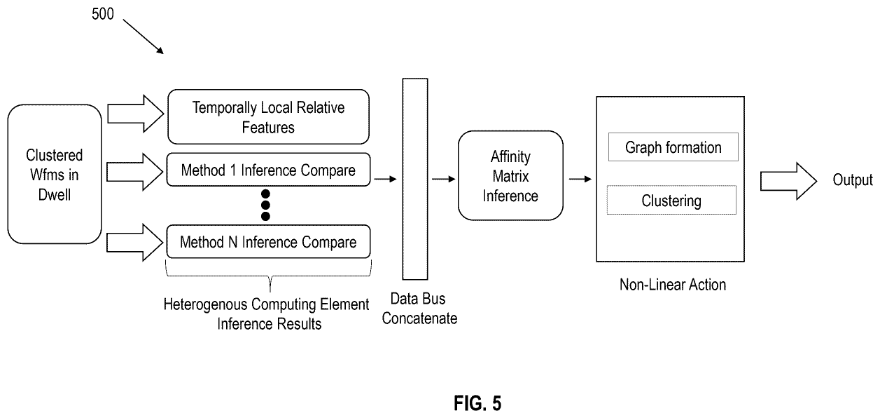

FIG. 5 illustrates de-interleaving according to some embodiments. The de-interleaving 500 shown in FIG. 5 includes unsupervised machine learning to separate the PDWs from different emitters and cluster the PDWs during a dwell time (the time period over which signals are received, also referred to as a dwell or scheduling interval) using features of the PDWs extracted from the received signals. In particular, the de-interleaving may provide both normalized and relative feature generation or characteristics associated with the PDWs and thus emitters. The determination of the characteristics may be followed by creation or modification of an affinity matrix, and subsequently a waveform graph in which the distance metric is learned by a machine learning model and used to indicate likelihood of association of a particular waveform with another waveform or cluster of waveforms.

The input to the unsupervised machine learning algorithm is a collected set of waveforms, summarized by PDWs, from the current environment (the environment in the current scheduling interval). As above, RF pulses are collected from the current environment at a high sample rate, with each pulse being digitized and summarized into intrinsic and extrinsic parameters (e.g., center frequency, amplitude, modulation category, pulse width, . . . ) called a PDW to reduce the scale of the data being processed.

The individual PDWs are clustered into learned atomic clusters by an unsupervised ML clustering algorithm such as a Naive Bayes-based clustering algorithm to summarize the large collection of potentially noisy PDWs into central points (or centroids). In unsupervised ML, the clustering is performed without prior knowledge of the categories. The learned atomic clusters represent an initial attempt to organize the incoming signals into coherent groups that likely originate from the same emitter or same type of emitter. The learned cluster centers are the centroids of the learned atomic clusters. The centers may be calculated by averaging the characteristics of the PDWs within each cluster, effectively reducing the dimensionality of the data by one or more orders of magnitude and summarizing the key features of each group while increasing the accuracy of the measurement. In one example, 1024 PDWs stored in a PDW buffer were reduced by over an order of magnitude to result in 31 clusters.

The output of the unsupervised ML clustering algorithm is used to generate an enhanced feature set. This feature set includes temporally local relative features, which are calculated to capture the temporal relationships between the signals within the same dwell. The features are used for the subsequent affinity matrix inference, as the features provide a basis for determining the similarity between waveforms. One or more independent algorithms may be used to uncover patterns in the incoming PDW data stream. For example, detecting that an emission stops when another begins exposes a pattern in the temporal domain. Another orthogonal algorithm may quantify a consistent spacing in the frequency domain. Concatenating different orthogonal inferences may be used to begin to describe the “closeness” of two clusters. In this case, instead of attempting to label a cluster as being from “Emitter A” verses “Emitter B”, the algorithm infers the adjacency between two emissions. The differential style of comparison may be able to mitigate or eliminate bias in the feature measurements by performing a subtraction-like operation. Clustered PDWs from the same emitter may naturally be “closer” than PDWs from different emitters. For example, 31 learned cluster centers may produce 465 combinations, in which each combination has 17 normalized numbers that are used to describe the “closeness.” Note that this example is not intended to be limiting, additional algorithms may be used by adding the additional algorithms to the data bus through simple concatenation to the feature vector. To generate this, atomic cluster augmented feature generation algorithm uses the output from the feature generation for within-dwell affinity inference and further refines the feature set by concatenating additional features based on other hardware measurements or algorithms. A cluster combination (i,j) input feature vector represents the specific features that are used to determine the similarity between pairs of waveforms within the same dwell. These features are input into an affinity matrix inference module, which computes the likelihood that pairs of waveforms belong to the same emitter.

For each combination, the ML model processes an n-dimensional (e.g., 16-dimension) input together to infer a single affinity via an affinity matrix inference module. The behavior of the ML model is trained based on simulated interactions and environments. The combinations are iterated over to produce a matrix of values referred to as the affinity matrix. In one example, an XGBoost (Extreme Gradient Boosting) model is used. The XGBoost model is a scalable, distributed gradient-boosted decision tree (GBDT) machine learning library that provides parallel tree boosting for regression, classification, and ranking problems. However, the XGBoost model is only one of a number of ML models that may be used—that is, in other embodiments, other ML models may be used.

The XGBoost model uses supervised machine learning, decision trees, ensemble learning, and gradient boosting. In supervised machine learning, algorithms train the model to find patterns in a dataset with labels and features; the trained model is subsequently used to predict the labels on features of a new dataset. Decision trees create a model that predicts a label by evaluating a tree of if-then-else true/false feature questions and estimating the minimum number of questions to assess the probability of making a correct decision. Decision trees may be used for classification to predict a category or regression to predict a continuous numeric value. A GBDT is a decision tree ensemble learning algorithm that is similar to a random forest and that combines multiple machine learning algorithms to obtain an improved model. Gradient boosting is used to improve a single weak model by combining such a model with other weak models to generate a collectively strong model. Gradient boosting is an extension of boosting where the process of additively generating weak models is formalized as a gradient descent algorithm over an objective function. Gradient boosting sets targeted outcomes for the next model to minimize errors. Targeted outcomes for each case are based on the gradient of the error (hence the name gradient boosting) with respect to the prediction.

Unlike a Euclidian distance, the ML model learns the nuances and relative importance between the input variables. For example, certain algorithms may work better when the frequency difference is small. The ML model learns how to optimally combine the various sensor measurements into a single number to represent the affinities of two clusters.

The affinity matrix inference module thus uses the temporally local relative features and computes the affinity matrix using non-linear activation functions to process the relative features and generate the affinity matrix. The output is an optimized grouping of the signals based on the affinity matrix and the learned atomic clusters. The optimized grouping is used to identify and track the behavior of emitters.

In some examples, the system may also include a confidence estimator, which assesses the confidence level of the associations made by the affinity matrix inference module. The confidence estimator may use various statistical or machine learning methods to evaluate the reliability of the inferred associations. In some embodiments, a learned cluster number represents the identifier of the cluster to which a particular set of PDWs has been assigned based on their signal characteristics. The learned cluster number is an output from the unsupervised clustering process. A supervised relative emission probability is a measure calculated by the system that indicates the likelihood that a given PDW or a group of PDWs corresponds to a particular type of emitter. This probability is determined using a supervised learning approach, where the system has been trained on labeled data to recognize patterns associated with different emitters. An IsoForest Wfm Confidence Estimation may be used to assess the confidence of the supervised relative emission probability. The Isolation Forest algorithm is a type of ensemble learning method and may be used to detect anomalies and assign a confidence score to the emission probability. This score reflects the degree of certainty the system has in the inference. The confidence estimator uses the anomaly score from the IsoForest Wfm Confidence Estimation as a metric to gauge the confidence in the supervised inference. The confidence estimator may consider various factors, such as the consistency of the signal features with known emitter profiles, to determine the reliability of the association made between the PDWs and the emitter. The output of the confidence estimator is a confidence score, which is a quantified representation of the system confidence in the supervised inference. This score can be used to inform decision-making processes within the radar signal processing system, such as whether to accept, reject, or further investigate the inferred association between the PDWs and the emitter.

Typically, the number and type of emitters in an EW environment are unknown, as is whether the emitters are in the library of known threats. This is particularly true in military-tactical scenarios with limited intelligence collection. While supervised ML processing alone may be performed, such processing may perform relatively well when only “in library” emitters are present in the environment; supervised ML processing may break down or have significant limitation when exposed to unseen threats. The differential analysis followed by hierarchical clustering targets an open-classification problem in which the number of classes is unknown.

Hierarchical clustering may be used by a hierarchical clustering module and is able to process the graph by analyzing the graph topology from the bottom-up. The hierarchical clustering algorithm processes the affinity matrix instead of each individual graph edge. The hierarchical clustering module applies the hierarchical clustering algorithm to organize the waveforms into a dendrogram, which illustrates the arrangement of the clusters formed based on the similarity measures. The hierarchical clustering module processes the graph topologies to identify natural groupings within the data.

The hierarchical clustering module determines a cut distance within the dendrogram. The cut distance is a threshold value that dictates where the dendrogram is ‘cut’ to form distinct clusters. This value is adjustable and can be set based on mission-specific requirements, such as the desired level of granularity in the clustering or operational constraints. The result of the hierarchical clustering is a set of inferred single emitters, which are the waveforms that have been grouped together based on their high affinity scores. The inferred single emitters represent an optimal estimation of which waveforms are associated with individual radar sources. The normalized distance threshold is a parameter that can be used to scale the affinity scores within the affinity matrix. The scaling helps to standardize the scores across different sets of data, facilitating the comparison and interpretation of the results.

In the next scheduling interval, the graph may be re-calculated dependent on the collection in the previous scheduling interval. This permits the feature processing and graph formation to be adaptive dependent on patterns and current behaviors in the environment.

The clustering in an adjacency matrix, as well as the feature generators, thus includes arbitrating multiple selected supervised and/or supervised ML algorithms to infer adjacency and generate relative features based on dissimilarity. Similarly, the deinterleaving and tracking may handle multiple unknown waveforms in the environment and may be able to account for blended behaviors or ambiguity in the waveforms.

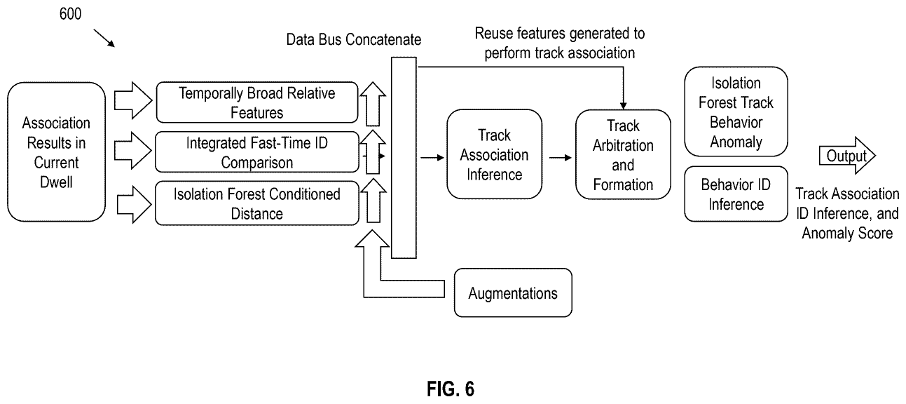

FIG. 6 illustrates a tracking block diagram according to some embodiments. The input to the tracking block 600 shown in FIG. 6 may be the output of the deinterleaving process shown in FIG. 5, i.e., the optimized PDW grouping. In other embodiments, if the optimized PDW grouping is supplied by a different module (other than that used to provide the deinterleaving process), the processes shown in FIGS. 5 and 6 may operate independently.

The tracking block 600 shown in FIG. 6 provides a self-supervised ML algorithm that infers threat identification, behavioral evolution, and quantifies the level of anomalous behavior based off emission patterns at the frame and sub-frame (about 1 ms to about 1000 ms) time scale. The self-supervised ML algorithm may use an aggregate of information at larger time scales. The newly learned behaviors, uncovered at longer timescales, may drive augmentation of a D-MDF. The D-MDF is used to store behavior information that can be used in later inference, intelligence collection, and/or re-training. The inference results are used to supply a richer feature set to an AEF to inform successful EA or other ML-based algorithms.

As indicated above, although the association results to the tracking block 600 may be provided for the current dwell from the deinterleaving process shown in FIG. 5, in other embodiments, other sources of this information may be used. That is, the groupings obtained may be provided by an association algorithm in a different module so that the groupings made at shorter timescales may be provided to determine the longer-term behavioral analysis.

Information may be combined from a number of different sources to provide a normalized distance between two waveforms. The examples provided use three main sources of information: relative features, the supervised ML model that inferred the waveform identification, and an anomaly detector/confidence estimator.

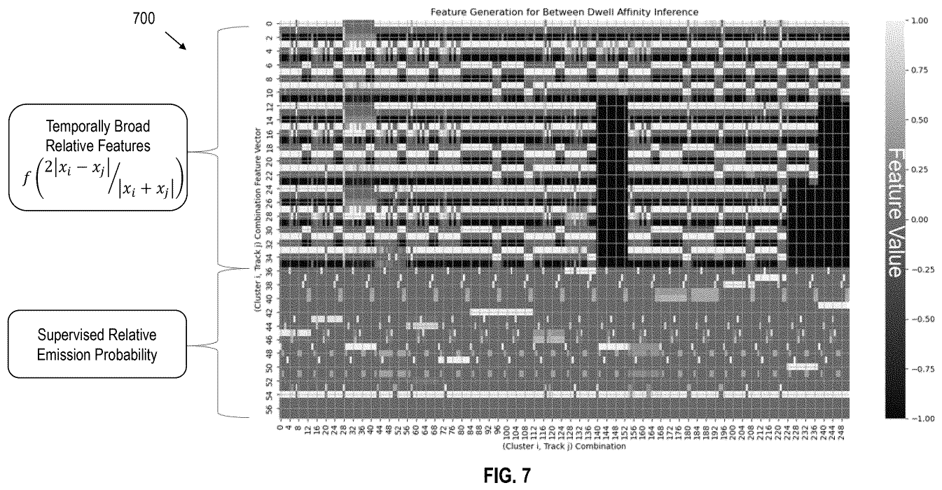

Features are generated by comparing the current distribution of multiple inferred groupings to the recent historical behavior contained in the DEL (e.g., the previous 1-10 dwells). This allows the DEL to save the current state of the belief of the association algorithm of the current environment. The length of history may be modified dependent on a desired balance between how dynamic the emitter is thought to be (i.e., how fast the emitter is likely to change waveforms emitted therefrom) and the hardware memory requirements within the system. While the full history may be saved in the D-MDF, the temporal horizon for the association algorithm may be set to be less than the total history. FIG. 7 illustrates feature generation with a DEL according to some embodiments.

Tracks in the graph 700 indicate the presence of emitters in the environment. In some embodiments, a single track is created per emitter. The track contains the history of emissions of the emitter. Comparisons of the distribution of features (e.g., frequency, pulse width, inferred identification) from the fast-time algorithm and the recent D-MDF history may be performed to infer whether the grouping is to be associated to a current track or used to create a new track. A new track indicates the presence of a new emitter.

The approach is differential and adaptive by performing a comparison to the D-MDF state. In future scheduling intervals, the graph 700 may save earlier decisions. The decisions may be used to adjust the algorithm logic at inference time. As the state of knowledge of the environment evolves, the D-MDF data structure preserves the learned patterns for future comparison.

FIG. 7 illustrates an example of 57 features (y axis) that have been generated by comparing 14 learned groupings to 18 tracks. This creates a total of 252 (14×18) combinations (x axis), which enumerates the edges of the graph to be constructed. The 57 features include 35 relative features that are temporally broad, as well as 22 features related to a supervised relative emission probability. The temporally broad features are defined by equation (1) below, where i is the cluster and j is the track.

$$f ( 2 \vert {x}_{i} - {x}_{j} \vert / \vert {x}_{i} + {x}_{j} \vert ) \qquad ( 1 )$$

As indicated in equation (1), the relative features may be described as the difference between feature of the waveforms divided by the mean of the feature of the waveforms described by the PDWs. One such feature may be the frequency (i.e., the frequency difference between the waveforms divided by the mean of the frequencies), thereby providing a relative frequency distance between the waveforms. As above, other features described by the PDWs may be used, including pulse width, duty cycle, pulse amplitude and others.

The ML model infers the identification of the waveform (Threat_name_1, Threat_name_2, . . . ) using absolute values of intrinsic features of the waveform. That is, the absolute collected frequency and pulse width are used to make a probabilistic inference about the waveform identification. As this is a comparison between two inferred vectors, one for each waveform, the inference is processed using the dot product, which is the probability the waveforms have the same identification.

The anomaly detector/confidence estimator generates features using the Isolation Forest algorithm to infer a normalized distance between the two waveforms as well as the distance from the waveform to the training data.

The x-axis of the graph 700 of FIG. 7 shows all waveform combinations, thereby enumerating all the edges of the graph 700 to be constructed. The information may be combined into a single number to resent the “closeness” of two waveforms. That single number is the edge length in the constructed graph 700. The edge length is not merely a Euclidian or similar distance between waveforms; instead, a supervised ML model is used that is optimally trained to process the relationship between the various sources of information. For example, the supervised ML model may learn that waveforms that are close in identification may only be associated if the waveforms have relative frequency within X % if their relative duty cycle is less than Y %; if the relative duty cycle is >Y % then the relative frequency of the waveforms may be within W % (W<X) for the waveforms to be associated. In some circumstances, the ML model may learn to ignore identification when the relative frequency (and/or another relative feature) is large. Features generated from previous algorithms (such as shown in FIG. 5) may be concatenated to quantify the similarity between the current dwell results and previously determined tracks.

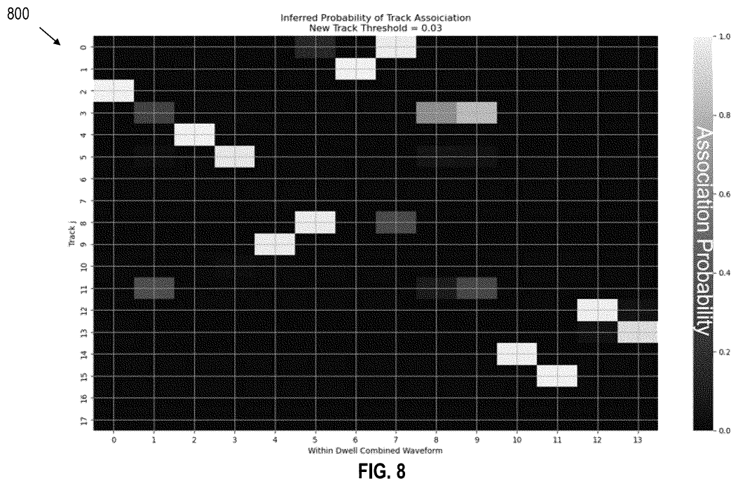

FIG. 8 illustrates track association inference according to some embodiments. The track association inference graph 800 of FIG. 8 shows the inferred probability distribution of all 252 combinations of FIG. 7. To produce a single number representing the probability of association, an XGBoost model infers the probability from the learned processing of the 58 normalized differential measurements. The learning is performed by training the model on example simulations. This permits the model to learn nuanced decision making to combine all the inputs non-linearly into a single probability value. A maximum likelihood approach may be implemented to assign the combined waveforms into tracks. A new track is formed by the model in response to the probability being less than a predetermined value.

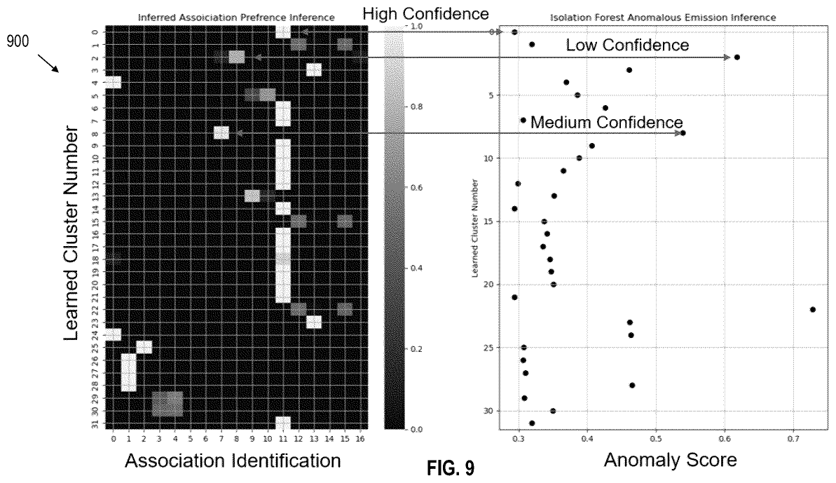

The 57 features generated to perform the track association may contain an analysis of the recent behavior of the threat emissions. These features may be reused to make identification inference at longer time scales that may expose underlying behavioral patterns. An Isolation Forest model may also be trained to detect anomalous behavior of the emitters. FIG. 9 illustrates identification inference and anomaly score according to some embodiments.

The anomaly and ID metric 900 are shown in FIG. 9. One aspect of the model is that the behavior and anomaly analysis is dependent on differential measurements between the current scheduling interval and the history. By using differential measurements rather than absolute measurements, the model as able to generalize the behaviors. The use of an additional confidence metric in parallel to the probabilistic ID inference may further mitigate issues with ML models having difficulty judging probability.

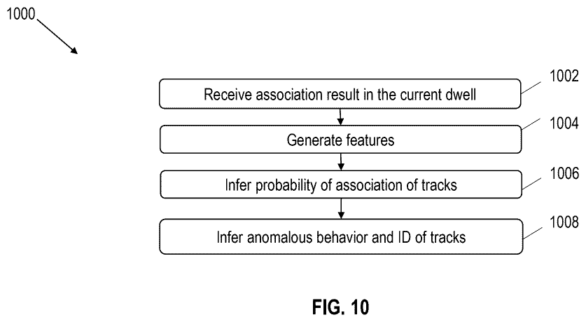

FIG. 10 illustrates a method of Behavioral Emitter Identification, Emission Tracking, and Anomaly Detection in accordance with some aspects. In some embodiments, the electronic device(s), network(s), system(s), chip(s) or component(s), or portions or implementations thereof may be configured to perform one or more processes, techniques, or methods as described herein, or portions thereof. Only some of the operations are shown in the process 1000 of FIG. 10; other operations may be present but are not shown.

At operation 1002, the self-supervised ML algorithm receives an association result in the current dwell. The association result may be an optimized grouping of PDWs, which may be supplied from the deinterleaver or from another module inside the system.

At operation 1004, features are generated based on a comparison between the current distribution of several inferred groupings to the recent behavior contained in the DEL. Each track in the DEL is associated with a different emitter in the EW environment. Comparisons of the distribution of features from the fast-time algorithm and the recent DEL history are performed to infer if the grouping should be associated to a current track or used to create a new track.

At operation 1006, the probability of association of the grouping to a track is inferred based on the learned processing normalized differential measurements. A new track is created for the grouping if the probability is below a minimum value.

At operation 1008, the same features used for track association are used to infer an emitter ID as well as anomalous behavior of the emitter.

The embodiments herein use a semi-supervised ML algorithm that infers threat identification, behavioral evolution, and quantifies the level of anomalous behavior based on emission patterns at the frame and sub-frame time scale while including DEL augmentation. The detailed inference results are used to supply a richer feature set to an AEF to inform successful EA. The system may use feature calculation that is dynamic and based on evolution of the DEL. Features are dependent on the current environment as well as the previous decisions and learned behaviors in that environment. The features used in the track association inference are normalized and relative to other emission patterns in the EW environment. Using relative quantities rather than absolute to infer affinity between two clustered waveforms increases generalizability of the model to unseen emissions. Both the normalized and relative features generated to perform track association inference may be re-used for the Behavior Anomaly and Behavior ID inference. This reduces computation time by using the same feature set aimed at quantifying the temporal evolution of the threat. A semi-supervised anomaly detection (isolation forest) at a latent layer of the ML algorithm may be used to infer deception, surprising behaviors, or processes being nefariously modified without labeled “anomalous” data. This approach may be extended for use in Deep Neural Networks (DNN). As supervised ML models can be poor at estimating a confidence metric, the anomaly score may be used as a separate method to estimate confidence in inference results and kept as an additional feature downstream.

### Examples

Example 1 is a system for emitter identification, emission tracking, and anomaly detection in an electronic warfare (EW) environment, the system comprising: an antenna array configured to receive waveforms from emitters in the EW environment; processing circuitry configured to use a self-supervised Machine Learning (ML) algorithm to: obtain association results of waveforms of the emitters in a current dwell, the association results including a current distribution of inferred groupings of the waveforms; generate features for each waveform through a comparison between the current distribution of inferred groupings and recent emitter historical behavior contained in a Dynamic Mission Data File (D-MDF); determine, for each waveform, a probability of association with a track based on the features generated through the comparison between the current distribution of inferred groupings and the recent emitter historical behavior contained in the D-MDF; and infer, for each waveform based on the probability, an identity of an emitter in the EW environment and anomalous behavior of the emitter to obtain inference results; and a memory configured to store the D-MDF.

In Example 2, the subject matter of Example 1 includes, wherein: the waveforms in the current dwell are represented as pulse descriptor words (PDWs) that describe intrinsic and extrinsic emitter characteristics or emitter features of the emitters, the intrinsic and extrinsic emitter characteristics or emitter features are selected from a group that includes Carrier Frequency (Fc), Pulse Width (PW), pulse repetition interval (PRI), signal bandwidth (BW), Pulse Amplitude (PA), Time of Arrival (TOA), Angle of Arrival (AOA), and Pulse Repetition Interval (PRI), and the association results are obtained from a deinterleaver configured to deinterleave the PDWs of the current dwell.

In Example 3, the subject matter of Examples 1-2 includes, wherein a length of history in the D-MDF is dependent on a balance between an estimated dynamicity of a particular emitter and hardware limitations of the memory.

In Example 4, the subject matter of Example 3 includes, wherein a temporal horizon for association of the waveforms with the particular emitter is less than a full history in the D-MDF for the particular emitter.

In Example 5, the subject matter of Examples 1˜4 includes, wherein the D-MDF contains one track per emitter, each track containing a history of emissions of an associated emitter.

In Example 6, the subject matter of Example 5 includes, wherein the processing circuitry is configured to compare a distribution of the features generated for each waveform and recent D-MDF history to infer whether the inferred grouping is to be associated to a current track, corresponding to an existing emitter in the EW environment, or used to create a new track corresponding to an existing emitter in the EW environment.

In Example 7, the subject matter of Example 6 includes, wherein the features include frequency, pulse width, and inferred identification of the waveform to the associated emitter.

In Example 8, the subject matter of Examples 6-7 includes, wherein the processing circuitry is configured to update the DEL based on results of a comparison of the distribution of the features generated for each inferred grouping and the recent DEL for the current dwell as an updated D-MDF and use the updated DEL in a future dwell.

In Example 9, the subject matter of Examples 6-8 includes, wherein the processing circuitry is configured to create the new track in response to a probability that the inferred grouping is to be associated to the current track is less than a predetermined value.

In Example 10, the subject matter of Examples 1-9 includes, wherein the processing circuitry is configured to reuse the features to make an identification inference and detect the anomalous behavior at longer time scales that the current dwell.

In Example 11, the subject matter of Example 10 includes, wherein the processing circuitry is configured to train an Isolation Forest model to detect the anomalous behavior.

In Example 12, the subject matter of Example 11 includes, wherein the processing circuitry is configured to use differential measurements between current measurement of the current dwell and historical measurements to generalize behaviors of emitters in the EW environment.

In Example 13, the subject matter of Examples 1-12 includes, wherein the processing circuitry is configured to, for each waveform: use the inference results to determine whether to employ countermeasures of an Electronic Attack (EA) based on the identity of the emitter in the EW environment; and in response to a determination to employ the countermeasures, generate the countermeasures for transmission by the antenna array.

Example 14 is a method of emitter identification and tracking in an electronic warfare (EW) environment, the method comprising: using semi-supervised machine learning (ML) to infer threat identification, behavioral evolution, and quantify anomalous behavior of emitters in an electronic warfare (EW) environment based on emission patterns on a frame and sub-frame time scale to generate inference results; using the inference results to supply a feature set to an Active Emitter File (AEF) to determine an Electronic Attack (EA); and generating countermeasures of the EA for transmission in the EW environment.

In Example 15, the subject matter of Example 14 includes, generating features of clustered waveforms for track association inference that are normalized and relative to other emission patterns in the EW environment.

In Example 16, the subject matter of Example 15 includes, reusing the features for track association for the anomalous behavior and identification inference.

In Example 17, the subject matter of Example 16 includes, using unsupervised anomaly detection at a latent layer of an algorithm used for the anomalous behavior inference to infer deception, unknown behavior, or modified processes of a known emitter in the EW environment.

In Example 18, the subject matter of Examples 15-17 includes, creating a new track based on a probability of association with an existing track being less than a predetermined probability, each track associated with a single emitter in the EW environment and related to a different set of features.

Example 19 is a non-transitory computer-readable medium storing instructions that, when executed by a processor in an electronic warfare (EW) environment, cause the processor to: obtain association results of waveforms of emitters in the EW environment in a current dwell, the association results including a current distribution of inferred groupings of the waveforms; generate features for each waveform through a comparison between the current distribution of inferred groupings and recent emitter historical behavior contained in a Dynamic Emitter Library (DEL); determine, for each waveform, a probability of association with a track based on the features generated through the comparison between the current distribution of inferred groupings and the recent emitter historical behavior contained in the D-MDF; infer, for each waveform based on the probability, an identity of an emitter in the EW environment and anomalous behavior of the emitter to obtain inference results; use the inference results to determine whether to employ countermeasures of an Electronic Attack (EA) based on the identity of the emitter in the EW environment; and in response to a determination to employ the countermeasures, generate the countermeasures for transmission in the EW environment.

In Example 20, the subject matter of Example 19 includes, wherein: a length of history in the DEL is dependent on a balance between an estimated dynamicity of each emitter and hardware limitations of a memory storing the DEL, and a temporal horizon for association of the waveforms with each emitter is less than a full history in the D-MDF for the emitter.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although embodiments have been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. For example, the term “a processor” configured to carry out specific operations includes both a single processor configured to carry out all of the operations as well as multiple processors individually configured to carry out some or all of the operations (which may overlap) such that the combination of processors carry out all of the operations. Note that the term “about x” and similar terms (e.g., substantially) as used herein may be understood to be within 10% of x or otherwise within a range known to one of skill in the art to be within tolerance of the quantity or quality described unless indicated otherwise.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A system for emitter identification, emission tracking, and anomaly detection in an electronic warfare (EW) environment, the system comprising:
processing circuitry configured to use a self-supervised Machine Learning (ML) algorithm to:
obtain association results of waveforms of emitters in the EW environment in a current dwell, the association results including a current distribution of inferred groupings of the waveforms;
generate features for each waveform through a comparison between the current distribution of inferred groupings and recent emitter historical behavior contained in a Dynamic Emitter Library (DEL);
determine, for each waveform, a probability of association with a track based on the features generated through the comparison between the current distribution of inferred groupings and the recent emitter historical behavior contained in the DEL; and
infer, for each waveform based on the probability, an identity of an emitter in the EW environment and anomalous behavior of the emitter to obtain inference results; and
a memory configured to store the DEL.

2. The system of claim 1, wherein:
the waveforms in the current dwell are represented as pulse descriptor words (PDWs) that describe intrinsic and extrinsic emitter characteristics or emitter features of the emitters,
the intrinsic and extrinsic emitter characteristics or emitter features are selected from a group that includes Carrier Frequency (Fc), Pulse Width (PW), pulse repetition interval (PRI), signal bandwidth (BW), Pulse Amplitude (PA), Time of Arrival (TOA), Angle of Arrival (AOA), and Pulse Repetition Interval (PRI), and
the association results are obtained from a deinterleaver configured to deinterleave the PDWs of the current dwell.

3. The system of claim 1, wherein a length of history in the DEL is dependent on a balance between an estimated dynamicity of a particular emitter and hardware limitations of the memory.

4. The system of claim 3, wherein a temporal horizon for association of the waveforms with the particular emitter is less than a full history in the DEL for the particular emitter.

5. The system of claim 1, wherein the DEL contains one track per emitter, each track containing a history of emissions of an associated emitter.

6. The system of claim 5, wherein the processing circuitry is configured to compare a distribution of the features generated for each waveform and recent DEL history to infer whether the inferred grouping is to be associated to a current track, corresponding to an existing emitter in the EW environment, or used to create a new track corresponding to an existing emitter in the EW environment.

7. The system of claim 6, wherein the features include frequency, pulse width, and inferred identification of the waveform to the associated emitter.

8. The system of claim 6, wherein the processing circuitry is configured to update the DEL based on results of a comparison of the distribution of the features generated for each inferred grouping and the recent DEL for the current dwell as an updated DEL and use the updated DEL in a future dwell.

9. The system of claim 6, wherein the processing circuitry is configured to create the new track in response to a probability that the inferred grouping is to be associated to the current track is less than a predetermined value.

10. The system of claim 1, wherein the processing circuitry is configured to reuse the features to make an identification inference and detect the anomalous behavior at longer time scales that the current dwell.

11. The system of claim 10, wherein the processing circuitry is configured to train an Isolation Forest model to detect the anomalous behavior.

12. The system of claim 11, wherein the processing circuitry is configured to use differential measurements between current measurement of the current dwell and historical measurements to generalize behaviors of emitters in the EW environment.

13. The system of claim 1, wherein the processing circuitry is configured to, for each waveform:
use the inference results to determine whether to employ countermeasures of an Electronic Attack (EA) based on the identity of the emitter in the EW environment; and
in response to a determination to employ the countermeasures, generate the countermeasures for transmission by an antenna array of the system.

14. A method of emitter identification and tracking in an electronic warfare (EW) environment, the method comprising:
using semi-supervised machine learning (ML) to infer threat identification, behavioral evolution, and quantify anomalous behavior of emitters in an electronic warfare (EW) environment based on emission patterns on a frame and sub-frame time scale to generate inference results;
using the inference results to supply a feature set to an Active Emitter File (AEF) to determine an Electronic Attack (EA); and
generating countermeasures of the EA for transmission in the EW environment.

15. The method of claim 14, further comprising generating features of clustered waveforms for track association inference that are normalized and relative to other emission patterns in the EW environment.

16. The method of claim 15, further comprising reusing the features for track association for the anomalous behavior and identification inference.

17. The method of claim 16, further comprising using unsupervised anomaly detection at a latent layer of an algorithm used for the anomalous behavior inference to infer deception, unknown behavior, or modified processes of a known emitter in the EW environment.

18. The method of claim 15, further comprising creating a new track based on a probability of association with an existing track being less than a predetermined probability, each track associated with a single emitter in the EW environment and related to a different set of features.

19. A non-transitory computer-readable medium storing instructions that, when executed by a processor in an electronic warfare (EW) environment, cause the processor to:
obtain association results of waveforms of emitters in the EW environment in a current dwell, the association results including a current distribution of inferred groupings of the waveforms;
generate features for each waveform through a comparison between the current distribution of inferred groupings and recent emitter historical behavior contained in a Dynamic Emitter Library (DEL);
determine, for each waveform, a probability of association with a track based on the features generated through the comparison between the current distribution of inferred groupings and the recent emitter historical behavior contained in the DEL;
infer, for each waveform based on the probability, an identity of an emitter in the EW environment and anomalous behavior of the emitter to obtain inference results;
use the inference results to determine whether to employ countermeasures of an Electronic Attack (EA) based on the identity of the emitter in the EW environment; and
in response to a determination to employ the countermeasures, generate the countermeasures for transmission in the EW environment.

20. The non-transitory computer-readable medium of claim 19, wherein:
a length of history in the DEL is dependent on a balance between an estimated dynamicity of each emitter and hardware limitations of a memory storing the DEL, and
a temporal horizon for association of the waveforms with each emitter is less than a full history in the DEL for the emitter.
